(19) United States
(12) Patent Application Publication
(10) Pub. No.: US 2024/0119494 A1
(43) Pub. Date: Apr. 11, 2024

(54) PRICING ENGINE FOR CONSUMERS ON A CONSUMER-TO-CONSUMER SELLING PLATFORM

(71) Applicant: INTERNATIONAL BUSINESS MACHINES CORPORATION, ARMONK, NY (US)

(72) Inventors: Raghuveer Prasad Nagar, Kota (IN); Subba Rayudu Tangirala, Bangalore (IN); Abhishek Solanki, LUCKNOW (IN); Jagadesh Ramaswamy Hulugundi, Bangalore (IN)

(21) Appl. No.: 17/938,080

(22) Filed: Oct. 5, 2022

(51) Int. Cl. G06Q 30/02

(52) U.S. Cl. CPC G06Q 30/0283; G06Q 30/0201; G06Q 30/0239

(57) ABSTRACT

According to one embodiment, a method, computer system, and computer program product for utilizing a pricing engine is provided. The present invention may include analyzing pricing factors of one or more products in an online listing; recommending a best price proposal to list the one or more products based on the analyzed pricing factors; analyzing buyer factors of a potential buyer; and recalculating the best price proposal based on the analyzed buyer factors.

### BACKGROUND

The present invention relates, generally, to the field of computing, and more particularly to electronic commerce.

Electronic commerce, otherwise known as e-commerce, involves the buying and selling of products and services online. E-commerce provides for marketplaces to exist remotely from a physical location. Currently, sellers can list their products online for chosen prices and buyers can then browse for and buy those products for the listed prices. However, no pricing engine exists for sellers to use to price their products, leaving the price to be chosen by the seller. Correctly pricing products is likely essential to a successful sale because if prices are too high, products risk not getting sold, and if prices are too low, the products might sell for a loss. Thus, an improvement in e-commerce has the potential to benefit consumers online.

### SUMMARY

According to one embodiment, a method, computer system, and computer program product for utilizing a pricing engine is provided. The present invention may include analyzing pricing factors of one or more products in an online listing; recommending a best price proposal to list the one or more products based on the analyzed pricing factors; analyzing buyer factors of a potential buyer; and recalculating the best price proposal based on the analyzed buyer factors.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an exemplary application invention environment according to at least one embodiment;

FIG. 3 is an operational flowchart illustrating a consumer pricing determination process according to at least one embodiment; and

FIG. 4 is an operational flowchart illustrating a pricing factors analysis process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

In a consumer-to-consumer (C2C) platform, a consumer, the seller, lists their products and/or offers their services to another consumer, the buyer. Currently, C2C platforms do not comprise a pricing engine and thus, a seller must choose a price for their listed product/services on their own. The chosen price of a product and/or service likely influences the outcome of its online listing, creating a discrepancy in the value the seller receives in the selling price of the product/service. For example, a couch may be listed online at a price that is too low, resulting in the couch selling for a loss, or too high, resulting in an inability to sell the couch because the listing may not be attracting sufficient buyer interest. Therefore, it may be likely that a seller does not choose a proper price for their listed product and as a result, experiences an unsuccessful product listing.

One way in which current methods attempt to address problems with sellers choosing a proper price for their products and/or services is by C2C platforms recommending a price range to a seller at which to list the product during the listing process. Specifically, C2C platforms can recommend a price range for the seller to list their product/service. For example, a C2C platform may recommend a price range of $20-$100 for a pair of sunglasses while the user is in the process of drafting a listing for the sunglasses on the C2C platform. However, while this method is helpful, it does not give a seller an actual price target and still leaves much of the price-choosing process up to the seller. One of the deficiencies of the current method is that the recommended price range is largely based on previous listings on the respective C2C platform and may only consider previous listings based on the name of the current listing and the condition of the product in the current listing. Specifically, the current method likely does not consider additional contextual information of previous listings such as a limited-edition listing of the product, which may have contributed to a price outlier, and thus, the C2C platform's price range recommendation to a seller would likely be misrepresentative of the real current value of the product. Thus, an improvement in e-commerce has the potential to improve a seller's chosen price for an online product listing and thus, benefit consumers in the e-commerce industry.

The present invention has the capacity to improve e-commerce by analyzing the pricing factors of a product in an online listing and analyzing buyer factors of a potential buyer to calculate and recommend a best price proposal to a seller. Accordingly, it may be advantageous to among other things, implement a system that improves the calculation of the price at which to offer a product and/or service so that the seller can achieve a successful sale of the product/service. For example, the program may propose a best price to list a seller's product that would result both in the online listing generating the interest of potential buyers and the seller receiving at least fair market value for the sale of their product. This improvement in the calculation of an offering price for a product/service can be accomplished by implementing a system that detects an online listing by a seller, analyzes pricing factors of the one or more products in the online listing, proposes a best price recommendation based on the analysis of pricing factors, analyzes buyer factors of potential buyers, and recalculates the best price proposal based on the analysis of buyer factors.

According to one embodiment, the invention is a system, method, and/or computer program product for utilizing a pricing engine to analyze the pricing factors of a product listing, propose a best price for the product listing based on the analysis of the pricing factors, analyze buyer factors of a potential buyer, and recalculate the best price proposal based on the analysis of the buyer factors.

In some embodiments of the invention, the consumer pricing determination program, herein referred to as “the program”, detects an online listing by a seller. The program can automatically detect an online listing when a seller lists one or more products for sale on the program. For example, a seller may upload a product listing to the program and the program may detect the listing. A seller may be a person who lists one or more products for sale on the program.

The program analyzes the pricing factors of the online listing using multiple machine learning algorithms. The pricing factors of an online listing can comprise similar product listing patterns across C2C platforms, similar buying listing patterns across C2C platforms, offers accepted and/or rejected for similar products, market trend data of the listed product(s), prices of the corresponding product in new condition, the age of the online listing, and/or reinforced learning. For example, if the program detects a listing for a bicycle that is in good condition and five years old, the program may analyze current listings on other C2C platforms that are for standard bicycles, new bicycles, used bicycles, similar model bicycles as the bicycle in the detected listing, bicycles in old and/or new condition, and may also analyze previous listings on other C2C platforms that were for new and/or old bicycles, etc. Reinforced learning can be based on explicit buyer/seller feedback, like transaction confirmations, implicit buyer/seller feedback, such as when a potential buyer views a listing and then purchases the same product from another listing, and the latest price at which the product was purchased from another listing. Additionally, the pricing factors may comprise the seller's affinity to negotiate, selling trends in different geographic regions, the seller's necessity level to sell, such as optional, desperate, urgent, or no rush, etc.

The program utilizes bagging algorithms, which encompass multiple machine learning models, in its analysis of the pricing factors of online listings. The bagging algorithms can enhance accuracy due to a large, varied set of dependent factors which play a role in proposing the best price for an online listing. The bagging algorithms learn both the pricing factors of online listings and the buyer factors of potential buyers, thereby analyzing the pricing of online listings. The bagging algorithms detect the pricing factors in an online listing and determine the impact each pricing factor had on the pricing of the listing. For example, the bagging algorithms may determine the primary reasons for the pricing of an online listing of a certain guitar were the prices at which the same guitar has previously been listed online and sold for and the infrequency at which the guitar appears in online listings. The program can learn the pricing factors of an online listing by analyzing previous online listings and/or predefined information. The program can update the bagging algorithms through continuous learning based on business transactions performed on the platform and can account for the data as feedback for reinforced learning and may incorporate price outliers into the algorithms for subsequent best price proposals.

When the program detects that a product is listed on more than one C2C platform, the program can leverage weight and ranking algorithms to compare the product listings on the different platforms. The program can connect to other C2C platforms through WAN. The program may use any APIs that are published by a C2C platform for programming access and the program can locate current and previous online listings through word searches. For example, eBay® has a developer API that is open and free for use. The weight and ranking algorithms can initially be predefined by the program and can be used to give weights to each listing and rank the multiple listings in order of most relevant to least relevant. The program can use the bagging algorithms to analyze the pricing factors of online listings on other C2C platforms. The program updates the weight and ranking algorithms through continuous learning based on business transactions performed on the program and on other C2C platforms and can account for the data as feedback for reinforced learning and may incorporate price outliers into the algorithms for subsequent best price proposals. The program may check other C2C platforms' listings at a frequency of at least once a day.

The program proposes a best price for the online listing based on the analysis of the pricing factors. The best price proposal can be the price that the program recommends at which the seller lists one or more products on the C2C platform. The program can compare the product(s) in the seller's detected listing to the pricing factors of the products in the analyzed online listings and can determine the best price proposal for the product(s) in the seller's detected listing based on the comparison. For example, based on the analysis of the pricing factors of analyzed online listings for the same and similar desks, in which the program determines that the desk in new condition is worth $120, the desk in used condition is worth $60, and that other comparable desks are priced similarly, the program proposes that the seller lists their desk online for $75 because the seller's listed desk is in used condition and is two years newer than the low range of used desks in the $60 price range.

The program may provide its justification for the best price proposal to the seller. In its justification, the program can detail its reasoning for the decided upon best price proposal. Continuing the previously stated example above, the program displays to the seller the program's textual analysis of the product(s) in the seller's detected listing, such as the program's determination that the desk in new condition is worth $120, the desk in used condition is worth $60, and that other desks are priced similarly, and that the program proposed that the seller lists their desk online for $75 because the seller's listed desk is in used condition and is two years newer than the low range of used desks in the $60 price range. In another example, the program may analyze other C2C platforms and identify a range of prices for similar listings, such as $220 through $240, and thus, in its justification, state that based on the prices of similar listings, the program determined $230 to be the best price to list the seller's product(s). The program may display its justification to the seller.

The program can attain seller feedback on the program's best price proposal for the online listing. The program attains seller feedback by displaying a prompt to the seller asking if the seller agrees with the best price proposal. The seller may either select “Yes” or “No” in response to the prompt. If the seller selects “Yes,” the program retains its original best price proposal. If the seller selects “No,” the program prompts the seller to enter the seller's modified best price proposal.

The program revises the best price proposal based on the seller's feedback. If the seller enters a modified best price proposal, the program revises the original best price proposal to match the seller's modified best price proposal. For example, if a seller enters a modified best price proposal of $400 as opposed to the program's best price proposal of $350, the program may change the initial best price proposal to match the modified best price proposal.

The program can analyze the buyer factors of a potential buyer. The buyer factors of a potential buyer can comprise social network connections between the seller and the buyer, and pricing specials. For example, if a buyer and a seller were connected on three different social media platforms, the program may hypothesize that the seller and buyer had a social relationship in some form. Pricing specials can comprise a discount on one or more products if the buyer purchases more quantity of a seller's product and/or multiple products from a seller's different listings. The program can utilize clustering techniques, such as K-means, to identify both connection affinities and aversion weight factors between the seller and potential buyers.

The program can recalculate the best price proposal based on the analysis of the buyer factors of a potential buyer. Based on the analysis of the buyer factors of the potential buyer, the program may recalculate the best price proposal for the potential buyer and in doing so, offer the product(s) to the potential buyer at a lower price than what the product(s) is listed for on the online listing. Continuing with the previously referenced example above, the program may recalculate the best price proposal based on the fact that the seller and the potential buyer likely had a social relationship, and thus, propose a recalculated price best price proposal of $15 to the potential buyer, instead of the listed best price proposal of $20. The program can still display the revised, and not the recalculated, best price proposal to other potential buyers.

An exemplary use of the invention may involve the program detecting an online listing by Andrew. Andrew listed his laptop for sale on the invention platform. The program analyzes the pricing factors for the laptop listing and recommends a best price proposal of $220. The program justifies its $220 best price proposal based on the program's analysis of similar product listings on other C2C platforms and displays it to Andrew. Subsequently, the program displays a prompt to Andrew, asking if he is okay with listing the laptop for the price of $220 and Andrew responds to the prompt by selecting the “Yes” button. Maria, an ex-colleague of Andrew's, has been checking various C2C platforms for a laptop and thus, is a potential buyer of Andrew's laptop. Maria has an active connection with Andrew on various social media platforms. Based on Andrew and Maria's online connections, the program recalculates the best price proposal to a price of $210 and offers Maria the laptop for that modified price. Concurrently, the best price proposal of $220 remains displayed to other potential buyers.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to detect an online product listing, analyze the pricing factors of the product, propose the best price to list the product based on the analysis of the pricing factors, analyze buyer factors of a potential buyer, and recalculate the best price proposal based on the analysis of the buyer factors.

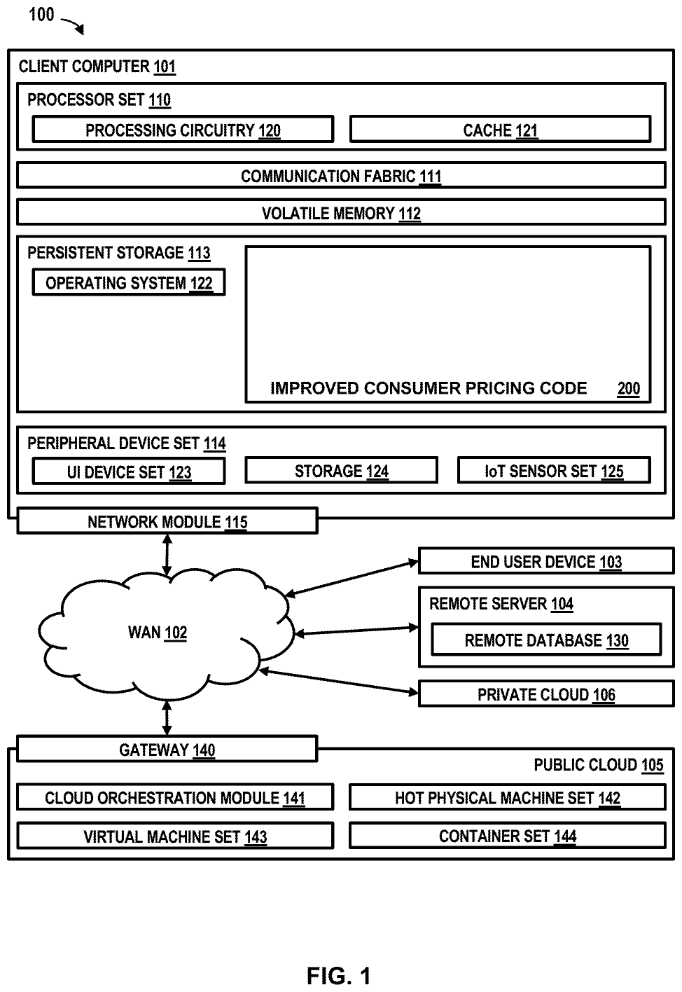

Referring to FIG. 1, an exemplary networked computer environment 100 is depicted, according to at least one embodiment. Computing environment 100 contains an example of an environment for the execution of at least some of the computer code involved in performing the inventive methods, such as improved consumer pricing code 200. In addition to code block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

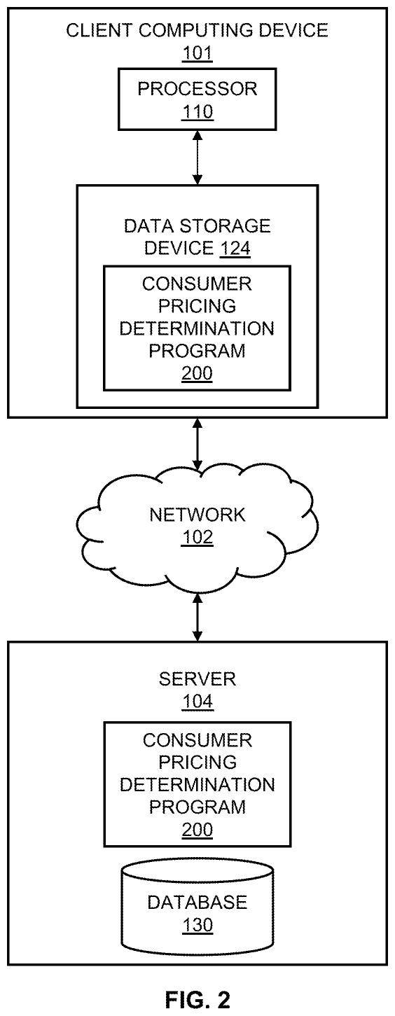

Referring to FIG. 2, an exemplary application environment is depicted, according to at least one embodiment. FIG. 2 may include client computing device 101 and a remote server 104 interconnected via a communication network 102. According to at least one implementation, FIG. 2 may include a plurality of client computing devices 101 and remote servers 104, of which only one of each is shown for illustrative brevity. It may be appreciated that FIG. 2 provides only an illustration of one implementation and does not imply any limitations with regard to the environments in which different embodiments may be implemented. Many modifications to the depicted environments may be made based on design and implementation requirements.

Client computing device 101 may include a processor 110 and a data storage device 124 that is enabled to host and run a consumer pricing determination program 200 and communicate with the remote server 104 via the communication network 102, in accordance with one embodiment of the invention.

The remote server computer 104 may be a laptop computer, netbook computer, personal computer (PC), a desktop computer, or any programmable electronic device or any network of programmable electronic devices capable of hosting and running a consumer pricing determination program 200 and a database 130 and communicating with the client computing device 101 via the communication network 102, in accordance with embodiments of the invention. The remote server 104 may also operate in a cloud computing service model, such as Software as a Service (SaaS), Platform as a Service (PaaS), or Infrastructure as a Service (IaaS). The remote server 104 may also be located in a cloud computing deployment model, such as a private cloud, community cloud, public cloud, or hybrid cloud.

The database 130 may be a digital repository capable of data storage and data retrieval. The database 130 can be present in the remote server 104 and/or any other location in the network 102. The database 114 may include a knowledge corpus that comprises the bagging algorithms, the weight and ranking algorithms, current and previous listings on the program 200, current and previous listings on other C2C platforms, analyzed pricing factors of listings, and analyzed buyer factors of potential buyers.

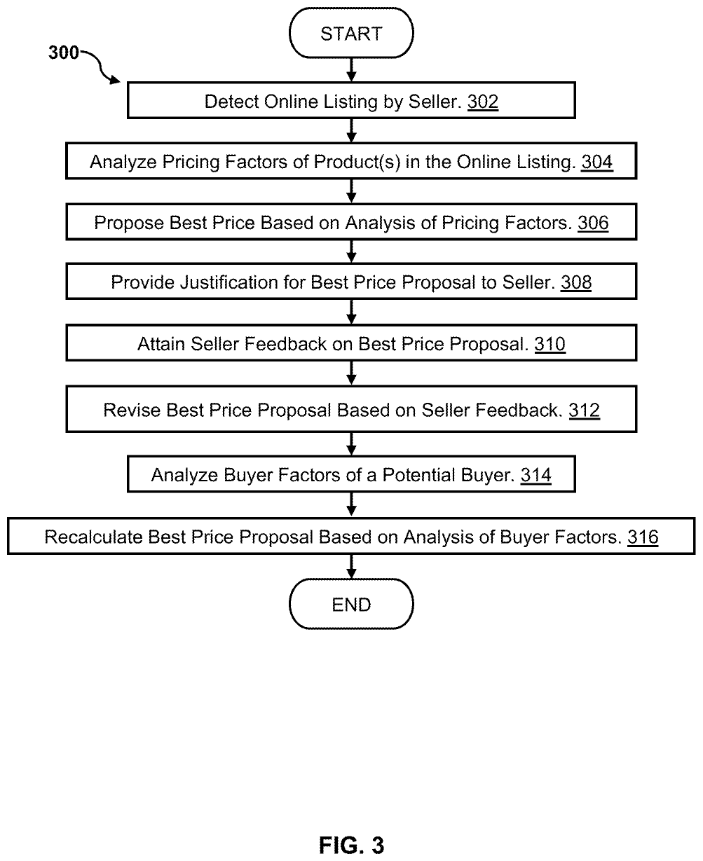

According to the present embodiment, the consumer pricing determination program 200 may be a program capable of detecting an online product listing, analyzing the pricing factors of the product, proposing the best price to list the product based on the analysis of the pricing factors, analyzing buyer factors of a potential buyer, and recalculating the best price proposal based on the analysis of the buyer factors. The consumer pricing determination program 200 may be located on client computing device 101 or remote server 104 or on any other device located within network 102. Furthermore, the consumer pricing determination program 200 may be distributed in its operation over multiple devices, such as client computing device 101 and remote server 104. The consumer pricing determination method is explained in further detail below with respect to FIG. 3.

Referring now to FIG. 3, an operational flowchart illustrating a consumer pricing determination process 300 is depicted according to at least one embodiment. At 302, the consumer pricing determination program 200, herein referred to as “the program”, detects an online listing by a seller. The program 200 can automatically detect an online listing when a seller lists one or more products for sale on the program 200.

At 304, the program 200 analyzes the pricing factors of the one or more products in the online listing using multiple machine learning algorithms. The pricing factors of an online listing can comprise similar product listing patterns across C2C platforms, similar buying listing patterns across C2C platforms, offers accepted and/or rejected for similar products, market trend data of the listed product(s), prices of the corresponding product in new condition, the age of the online listing, and/or reinforced learning. Reinforced learning can be based on explicit buyer/seller feedback, like transaction confirmations, implicit buyer/seller feedback, such as when a potential buyer views a listing and then purchases the same product from another listing, and the latest price at which the product was purchased for from another listing. Additionally, the pricing factors may comprise the seller's affinity to negotiate, selling trends in different geographic regions, the seller's necessity level to sell, such as optional, desperate, urgent, or no rush, etc.

The program 200 utilizes bagging algorithms, which encompass multiple machine learning models, in its analysis of the pricing factors of online listings. The bagging algorithms can enhance accuracy due to a large, varied set of dependent factors which play a role in proposing the best price for an online listing. The bagging algorithms learn both the pricing factors of online listings and the buyer factors of potential buyers, thereby analyzing the pricing of online listings. The bagging algorithms detect the pricing factors in an online listing and determine the impact each pricing factor had on the pricing of the listing. The program 200 can learn the pricing factors of an online listing by analyzing previous online listings and/or predefined information. The program 200 can update the bagging algorithms through continuous learning based on business transactions performed on the platform and can account for the data as feedback for reinforced learning and may incorporate price outliers into the algorithms for subsequent best price proposals.

When the program 200 detects that a product is listed on more than one C2C platform, the program 200 leverages weight and ranking algorithms for comparison purposes. The program 200 can connect to other C2C platforms through WAN 102. The program 200 may use any APIs that are published by a C2C platform for programming access and the program 200 can locate current and previous online listings through word searches. The weight and ranking algorithms can initially be predefined by the program 200 and can be used to give weights to each listing and rank the multiple listings in order of most relevant to least relevant. The program 200 can use the bagging algorithms to analyze the pricing factors of online listings on other C2C platforms. Through continuous learning, the program 200 updates the weight and ranking algorithms based on business transactions performed on the program 200 and on other C2C platforms and can account for the data as feedback for reinforced learning and may incorporate price outliers into the algorithms for subsequent best price proposals. The program 200 may check other C2C platforms' listings at a frequency of at least once a day.

At 306, the program 200 proposes the best price based on the analysis of pricing factors. The best price proposal can be the price that the program 200 recommends at which the seller lists one or more products on the C2C platform. The program 200 can compare the product(s) in the seller's detected listing to the pricing factors of the products in the analyzed online listings and can determine the best price proposal for the product(s) in the seller's detected listing based on the comparison.

At 308, the program 200 provides its justification for the best price proposal to the seller. In its justification, the program 200 can detail its reasoning for the decided upon best price proposal. The program 200 may display its justification to the seller.

At 310, the program 200 attains seller feedback on the best price proposal. The program 200 attains seller feedback by displaying a prompt to the seller asking if the seller agrees with the best price proposal. The seller may either select “Yes” or “No” in response to the prompt. If the seller selects “No,” the program 200 prompts the seller to enter the seller's modified best price proposal. If the seller selects “Yes,” the program 200 may proceed to step 312.

At 312, the program 200 revises the best price proposal based on the seller's feedback. If the seller enters a modified best price proposal, the program 200 revises the original best price proposal to match the seller's modified best price proposal. If the seller selected “Yes” in step 310, the program 200 retains its original best price proposal.

At 314, the program 200 analyzes the buyer factors of a potential buyer. The buyer factors of a potential buyer can comprise social network connections between the seller and the buyer, and pricing specials. Pricing specials can comprise a discount on one or more products if the buyer purchases more quantity of a seller's product and/or multiple products from a seller's different listings. The program 200 can utilize clustering techniques, such as K-means, to identify both connection affinities and aversion weight factors between the seller and potential buyers.

At 316, the program 200 recalculates the best price proposal based on the analysis of the buyer factors. Based on the analysis of the buyer factors of the potential buyer, the program 200 may recalculate the best price proposal for the potential buyer and in doing so, offer the potential buyer the product(s) for a lower price than what the product is listed for on the online listing. The program 200 can still display the revised, and not the recalculated, best price proposal to other potential buyers.

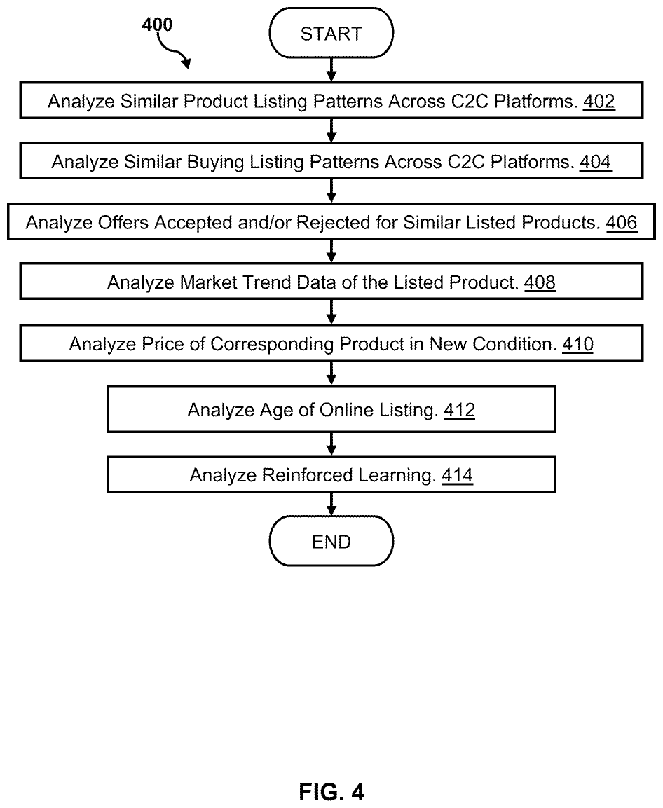

Referring now to FIG. 4, an operational flowchart illustrating a pricing factors analysis process 400 is depicted according to at least one embodiment. At 402, the program 200 analyzes similar product listing patterns across C2C platforms. At 404, the program 200 analyzes similar buying listing patterns across C2C platforms. At 406, the program 200 analyzes offers that were accepted and/or rejected for similar listed products. At 408, the program 200 analyzes market trend data of the listed product. At 410, the program 200 analyzes the prices of the corresponding product in new conditions. At 412, the program 200 analyzes the age of the online listing. At 414, the program 200 analyzes its reinforced learning. Based on the analysis of the pricing factors in steps 402 through 414, the program 200 may determine the best price proposal at which to list a seller's one or more products.

It may be appreciated that FIGS. 2-4 provide only illustrations of one implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for utilizing a pricing engine, the method comprising:
analyzing pricing factors of one or more products in an online listing;
recommending a best price proposal to list the one or more products based on the analyzed pricing factors;
analyzing buyer factors of a potential buyer; and
recalculating the best price proposal based on the analyzed buyer factors.

2. The method of claim 1, further comprising:
attaining a seller's feedback on the best price proposal; and
revising the best price proposal based on the seller's feedback.

3. The method of claim 1, wherein the analysis of the pricing factors of the one or more products in the online listing comprises utilizing one or more bagging algorithms.

4. The method of claim 1, wherein the pricing factors of the one or more products in the online listing comprise:
similar product listing patterns across one or more consumer-to-consumer platforms;
similar buyer listing patterns across the one or more consumer-to-consumer platforms;
offers accepted and/or rejected for similar listed products;
market trend data for the online listing;
price of corresponding product in new conditions;
age of the online listing; and/or
reinforced learning.

5. The method of claim 1, wherein the buyer factors of the potential buyer comprise:
social network connections between a seller and the potential buyer; and
pricing specials.

6. The method of claim 5, wherein the buyer factors of the potential buyer are identified using one or more clustering techniques.

7. The method of claim 1, wherein the analysis of the pricing factors of the one or more products in the online listing comprises utilizing one or more weight and ranking algorithms.

8. A computer system for utilizing a pricing engine, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
analyzing pricing factors of one or more products in an online listing;
recommending a best price proposal to list the one or more products based on the analyzed pricing factors;
analyzing buyer factors of a potential buyer; and
recalculating the best price proposal based on the analyzed buyer factors.

9. The computer system of claim 8, further comprising:
attaining a seller's feedback on the best price proposal; and
revising the best price proposal based on the seller's feedback.

10. The computer system of claim 8, wherein the analysis of the pricing factors of the one or more products in the online listing comprises utilizing one or more bagging algorithms.

11. The computer system of claim 8, wherein the pricing factors of the one or more products in the online listing comprise:
similar product listing patterns across one or more consumer-to-consumer platforms;
similar buyer listing patterns across the one or more consumer-to-consumer platforms;
offers accepted and/or rejected for similar listed products;
market trend data for the online listing;
price of corresponding new product in new conditions;
age of the online listing; and/or
reinforced learning.

12. The computer system of claim 8, wherein the buyer factors of the potential buyer comprise:
social network connections between a seller and the potential buyer; and
pricing specials.

13. The computer system of claim 12, wherein the buyer factors of the potential buyer are identified using one or more clustering techniques.

14. The computer system of claim 8, wherein the analysis of the pricing factors of the one or more products in the online listing comprises utilizing one or more weight and ranking algorithms.

15. A computer program product for utilizing a pricing engine, the computer program product comprising:
one or more computer-readable tangible storage medium and program instructions stored on at least one of the one or more tangible storage medium, the program instructions executable by a processor to cause the processor to perform a method comprising:
analyzing pricing factors of one or more products in an online listing;
recommending a best price proposal to list the one or more products based on the analyzed pricing factors;
analyzing buyer factors of a potential buyer; and
recalculating the best price proposal based on the analyzed buyer factors.

16. The computer program product of claim 15, further comprising:
attaining a seller's feedback on the best price proposal; and
revising the best price proposal based on the seller's feedback.

17. The computer program product of claim 15, wherein the analysis of the pricing factors of the one or more products in the online listing comprises utilizing one or more bagging algorithms.

18. The computer program product of claim 15, wherein the pricing factors of the one or more products in the online listing comprise:
similar product listing patterns across one or more consumer-to-consumer platforms;
similar buyer listing patterns across the one or more consumer-to-consumer platforms;
offers accepted and/or rejected for similar listed products;
market trend data for the online listing;
price of corresponding product in new conditions;
age of the online listing; and/or
reinforced learning.

19. The computer program product of claim 15, wherein the buyer factors of the potential buyer comprise:
social network connections between a seller and the potential buyer; and
pricing specials.

20. The computer program product of claim 19, wherein the buyer factors of the potential buyer are identified using one or more clustering techniques.
